(19) United States
(12) Patent Application Publication
(10) Pub. No.: US 2022/0411326 A1
(43) Pub. Date: Dec. 29, 2022

(54) METHOD FOR QUANTITATIVELY REGULATING CONTENT OF PERICLASE IN CEMENT

(71) Applicant: CHINA BUILDING MATERIALS ACADEMY, Beijing (CN)

(72) Inventors: Ma Zhongcheng, Beijing (CN); Wen Zhaijun, Beijing (CN); Wei Liying, Beijing (CN); Zhi Xiao, Beijing (CN); Liu Yun, Beijing (CN)

(21) Appl. No.: 17/830,231

(22) Filed: Jun. 1, 2022

(30) Foreign Application Priority Data
Jun. 28, 2021 (CN) 2021107220411

(51) Int. Cl. C04B 7/44; C04B 7/47; C04B 28/14

(52) U.S. Cl. CPC C04B 7/44; C04B 7/47; C04B 28/14

(57) ABSTRACT

The present invention relates to the technical field of building materials, in particular to a method for quantitatively regulating the content of periclase in cement. The method comprises: calculating calcination temperature according to formula I; and the formula I is as follows: z=(y−x+3.767)/0.0012 (I), wherein, x represents the content of MgO in the cement clinker, and the unit is wt %; y represents the target content of periclase in the cement, and the unit is wt %; and z represents the calcination temperature, and the unit is ° C. According to the method for quantitatively regulating the content of periclase in cement provided by the present invention, the expected content of periclase in cement can be more accurately obtained, which is more conducive to utilizing the expansion of cement to guide the practical requirements of cement applications in engineering.

### TECHNICAL FIELD

The present invention relates to the technical field of building materials, in particular to a method for quantitatively regulating the content of periclase in cement.

### BACKGROUND ART

In cement clinker, MgO exists in solid solution form or free crystal form, wherein, the MgO in solid solution form has no expansion, and the MgO existing in the form of free crystal (also known as periclase) will expand (in volume) by about 117% in the process of slow hydration, which has micro expansibility in the later stage. It can be seen that the content of periclase in cement directly affects the later expansion of cement. Therefore, in order to better guide the development of the later expansion of cement, how to effectively regulate the content of periclase in cement is very important.

At present, the research on the content of periclase in cement mainly focuses on the determination method of periclase content and the qualitative description of the influence of various factors such as MgO content, calcination temperature, cooling rate, doping and modulus value (lime saturation coefficient, silica modulus and alumina modulus) on the content of periclase in clinker. There is a lack of quantitative regulation technique for the content of periclase in cement, so it is impossible to accurately guide the effective development of the later expansion of cement.

CN106885752A discloses a method for determining the content (in mass) of periclase in cement. CN106969996A discloses a method for quantitatively determining the content (in mass) of periclase in cement by subtraction method. CN108548809A discloses a test method for the content of periclase in cement clinker. CN103592302A discloses a chemical method for quantitatively determining the content of periclase in cement clinker. CN103995012A discloses a method for testing the content of periclase in cement clinker and cement slurry by XRD. CN109374614A discloses a method for detecting the content of periclase in cement clinker based on a chemical method. CN109374613A discloses a method for detecting the content of periclase in cement clinker. However, these patent documents focus on different methods for determining the content of periclase in cement clinker or cement, and they have nothing to do with the regulation technique of periclase content.

CN105439481A discloses a method for improving the content of periclase in high-magnesium moderate heat cement clinker, which mainly uses metal elements such as manganese, vanadium, and titanium in vanadium-titanium slag to replace magnesium for solid solution to reduce the relative content of magnesia in solid solution form in clinker, thereby increasing the content of free magnesia in high-magnesium moderate heat cement clinker, and the method belongs to a qualitative technical method for increasing the content of periclase in cement by substitution method of trace metal elements.

It can be seen that there is an urgent need for a more accurate and effective quantitative regulation method for the content of periclase in cement, which is convenient to guide the later expansion of cement more accurately, so as to meet the expansion requirements of different projects.

### SUMMARY OF THE INVENTION

The present invention provides a method for quantitatively regulating the content of periclase in cement, which is hard to regulate, so as to more accurately evaluate the later expansion of the cement.

Specifically, the present invention provides the following technical solutions:

The present invention provides a method for quantitatively regulating the content of periclase in cement, comprising: calculating calcination temperature according to formula I; and the formula I is as follows:

z=(y−x+3.767)/0.0012 I;

wherein, x represents the content of MgO in cement clinker, the unit is wt %;

y represents the target content of periclase in cement, the unit is wt %; and

z represents the calcination temperature, the unit is ° C. The present invention finds that calcining cement raw materials at a specific temperature is expected to solve the existing problem that being hard to regulate the content of periclase in cement, and the formula I for calculating calcination temperature is further explored.

In order to more accurately and quantitatively regulate the content of periclase in cement, the present invention optimizes the above method, specifically as follows:

Preferably, the content of MgO in cement clinker is controlled between 2% and 6%.

Preferably, the calcination temperature is at 1350° C. to 1500° C.

Preferably, the method comprises the following steps:

(1) preparing cement raw meal to control the content of MgO in cement clinker being between 2% and 6%;

(2) calculating calcination temperature according to formula I as follows:

z=(y−x+3.767)/0.0012 I;

wherein, x represents the content of MgO in cement clinker, the unit is wt %;

y represents the target content of periclase in cement, the unit is wt %; and

z represents the calcination temperature, the unit is ° C.; and

(3) calcining the cement raw meal prepared in step (1) at the calcination temperature calculated in step (2), and cooling to obtain cement clinker.

Preferably, the method further comprises the step of mixing the cement clinker obtained in step (3) with gypsum and milling the resultant mixture.

As the preferred technical solution of the present invention, the method comprises the following steps:

(1) preparing cement raw meal to control the content of MgO in cement clinker being between 2% and 6%;

(2) calculating calcination temperature according to formula I as follows:

z=(y−x+3.767)/0.0012 I;

wherein, x represents the content of MgO in cement clinker, the unit is wt %;

y represents the target content of periclase in cement, the unit is wt %; and

z represents the calcination temperature, the unit is ° C.;

(3) calcining the cement raw meal prepared in step (1) at the calcination temperature calculated in step (2), and cooling to obtain cement clinker; and

(4) mixing the cement clinker obtained in step (3) with gypsum and milling the resultant mixture to obtain cement with the expected content of periclase.

Compared with the prior art, the present invention has the following beneficial effects:

According to the method for quantitatively regulating the content of periclase in cement provided by the present invention, the expected periclase content in cement can be more accurately obtained, which is more conducive to utilizing the expansion of cement to guide the practical requirements of cement applications in engineering.

### SPECIFIC MODES FOR CARRYING OUT THE EMBODIMENTS

The following Examples are intended to illustrate the present invention, but are not intended to limit the scope of the present invention.

If the specific technology or condition is not indicated in Examples, it shall be carried out in accordance with the technology or condition described in the documents in the art or in accordance with the product specification. If the reagents or instruments used in the present invention are without indicated manufacturer, they will be conventional products that can be purchased through regular channels.

### EXAMPLES 1-9

Examples 1-9 carry out important parameter regulation and the measurement of periclase content for cement with different periclase contents, specifically as follows:

In Examples 1 to 9, the raw materials from Huaxin Cement (Kunming Dongchuan) Co., Ltd. were used to prepare cement with different periclase contents. The content of periclase in the prepared cement was determined by “Quantitative determination the content (in mass) of periclase in cement by subtraction method” (refer to Chinese patent No. ZL 201710183748.3), so as to verify the accuracy of the method provided by the present invention.

The regulation of important parameters and the measured content of periclase in cement in Examples 1-9 are shown in Table 1. It can be seen from Table 1 that the difference between the measured content and the target content of periclase in cement is very small, within 0.02% for all Examples, indicating that the method for quantitatively regulating the content of periclase in cement provided by the present invention is reliable and accurate.

TABLE 1
Regulation of important parameters of cement with different periclase
contents and measured results of periclase content in cement

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| Content of MgO in | 2 | 2.5 | 3 | 3.5 | 4 | 4.5 | 5 | 5.5 | 6 |
| cement clinker/% | | | | | | | | | |
| Target content of | 0.033 | 0.353 | 0.973 | 1.413 | 1.913 | 2.473 | 3.033 | 3.353 | 4.033 |
| periclase in cement/% | | | | | | | | | |
| Calcination temperature/ | 1500 | 1350 | 1450 | 1400 | 1400 | 1450 | 1500 | 1350 | 1500 |
| ° C. | | | | | | | | | |
| Measured content of | 0.034 | 0.345 | 0.958 | 1.428 | 1.926 | 2.464 | 3.015 | 3.339 | 4.041 |
| periclase in cement/% | | | | | | | | | |
| Difference between | 0.001 | −0.008 | −0.015 | 0.015 | 0.013 | −0.009 | −0.018 | −0.014 | 0.008 |
| measured content and | | | | | | | | | |
| target content of | | | | | | | | | |
| periclase in cement/% | | | | | | | | | |

Although the present invention has been described in detail with general description and specific embodiments, it is obvious to a person skilled in the art that some modifications or improvements can be made on the basis of the present invention. Therefore, these modifications or improvements made without departing from the spirit of the present invention are all within the scope of the claimed protection of the present invention.

1. A method for quantitatively regulating the content of periclase in cement, comprising: calculating calcination temperature according to formula I; and the formula I is as follows:
z=(y−x+3.767)/0.0012 I;
wherein, x represents the content of MgO in cement clinker, the unit is wt %;
y represents the target content of periclase in cement, the unit is wt %; and
z represents the calcination temperature, the unit is ° C.

2. The method according to claim 1, wherein the content of MgO in cement clinker is controlled between 2% and 6%.

3. The method according to claim 1, wherein the calcination temperature is at 1350° C. to 1500° C.

4. The method according to claim 2, wherein the calcination temperature is at 1350° C. to 1500° C.

5. The method according to claim 1, comprising the following steps:
(1) preparing cement raw meal to control the content of MgO in cement clinker being between 2% and 6%;
(2) calculating calcination temperature according to formula I as follows:
z=(y−x+3.767)/0.0012 I;
wherein, x represents the content of MgO in cement clinker, the unit is wt %;
y represents the target content of periclase in cement, the unit is wt %; and
z represents the calcination temperature, the unit is ° C.; and
(3) calcining the cement raw meal prepared in step (1) at the calcination temperature calculated in step (2), and cooling to obtain cement clinker.

6. The method according to claim 2, comprising the following steps:
(1) preparing cement raw meal to control the content of MgO in cement clinker being between 2% and 6%;
(2) calculating calcination temperature according to formula I as follows:
z=(y−x+3.767)/0.0012 I;
wherein, x represents the content of MgO in cement clinker, the unit is wt %;
y represents the target content of periclase in cement, the unit is wt %; and
z represents the calcination temperature, the unit is ° C.; and
(3) calcining the cement raw meal prepared in step (1) at the calcination temperature calculated in step (2), and cooling to obtain cement clinker.

7. The method according to claim 3, comprising the following steps:
(1) preparing cement raw meal to control the content of MgO in cement clinker being between 2% and 6%;
(2) calculating calcination temperature according to formula I as follows:
z=(y−x+3.767)/0.0012 I;
wherein, x represents the content of MgO in cement clinker, the unit is wt %;
y represents the target content of periclase in cement, the unit is wt %; and
z represents the calcination temperature, the unit is ° C.; and
(3) calcining the cement raw meal prepared in step (1) at the calcination temperature calculated in step (2), and cooling to obtain cement clinker.

8. The method according to claim 4, comprising the following steps:
(1) preparing cement raw meal to control the content of MgO in cement clinker being between 2% and 6%;
(2) calculating calcination temperature according to formula I as follows:
z=(y−x+3.767)/0.0012 I;
wherein, x represents the content of MgO in cement clinker, the unit is wt %;
y represents the target content of periclase in cement, the unit is wt %; and
z represents the calcination temperature, the unit is ° C.; and
(3) calcining the cement raw meal prepared in step (1) at the calcination temperature calculated in step (2), and cooling to obtain cement clinker.

9. The method according to claim 5, further comprising the step of mixing the cement clinker obtained in step (3) with gypsum and milling the resultant mixture.

10. The method according to claim 6, further comprising the step of mixing the cement clinker obtained in step (3) with gypsum and milling the resultant mixture.

11. The method according to claim 7, further comprising the step of mixing the cement clinker obtained in step (3) with gypsum and milling the resultant mixture.

12. The method according to claim 8, further comprising the step of mixing the cement clinker obtained in step (3) with gypsum and milling the resultant mixture.

13. The method according to claim 1, comprising the following steps of:
(1) preparing cement raw meal to control the content of MgO in cement clinker being between 2% and 6%;
(2) calculating calcination temperature according to formula I as follows:
z=(y−x+3.767)/0.0012 I;
wherein, x represents the content of MgO in cement clinker, the unit is wt %;
y represents the target content of periclase in cement, the unit is wt %; and
z represents the calcination temperature, the unit is ° C.;
(3) calcining the cement raw meal prepared in step (1) at the calcination temperature calculated in step (2), and cooling to obtain cement clinker; and
(4) mixing the cement clinker obtained in step (3) with gypsum and milling the resultant mixture.
